(19) United States
(12) Patent Application Publication
(10) Pub. No.: US 2014/0155266 A1
(43) Pub. Date: Jun. 5, 2014

(54) POTENTIATOR FOR SOLUBLE LIQUID HERBICIDE

(71) Applicants: Khak Wai Kew, Negeri Sembilan (MY); Siew Hwa Tan, Klang (MY); Leh Hung Wong, Klang (MY); Soon Chee Yap, Puchong (MY)

(72) Inventors: Khak Wai Kew, Negeri Sembilan (MY); Siew Hwa Tan, Klang (MY); Leh Hung Wong, Klang (MY); Soon Chee Yap, Puchong (MY)

(73) Assignee: Emery Oleochemicals (M) SDN. BHD, Telok Panglima Garang, Selangor (MY)

(21) Appl. No.: 13/883,201

(22) PCT Filed: Oct. 28, 2011
(86) PCT No.: PCT/MY2011/000227

§ 371 Date: Feb. 18, 2014

(30) Foreign Application Priority Data
Oct. 29, 2010 (MY) PI2010005109

(51) Int. Cl. A01N 25/04; A01N 25/30

(52) U.S. Cl. CPC A01N 25/04; A01N 25/30
USPC 504/206; 252/194; 516/69

(57) ABSTRACT

An emulsion composition for use as potentiator in a soluble liquid herbicide formulation comprising a natural oil-based ester, a hydrophilic surfactant, a lipophilic surfactant, a natural oil-based ethanol amide co-surfactant and a natural oil-based glyceride ethoxylate co-surfactant.

### FIELD OF INVENTION

The present invention relates to a potentiator for enhancing the performance of active ingredients in an agrochemical. More particularly, the present invention relates to a potentiator for both ionic and nonionic soluble liquid herbicide formulations including herbicide formulations with active ingredients such as glyphosate.

### BACKGROUND OF THE INVENTION

The term agrochemicals refers to a broad range of chemical products used in agriculture, including pesticides, fungicides, bactericides, biocides, herbicides, insecticides, miticides, as well as fertilizers, hormones, plant growth regulators and concentrated stores of animal manure. Conventionally, agrochemicals contain organic compounds which are insoluble or poorly soluble in water, thus a substantially complicated handling process is involved before these agrochemicals can be used in the field. For a number of economical and ecological reasons, water-based agrochemical formulations are increasingly desired.

In recent years, numerous effort has been put into the research and development field of agrochemicals in order to provide more effective soluble liquid or water-based agrochemical formulations. For examples, various types of surfactants, oil-in-water emulsions or microemulsions have been used in agrochemical formulations for modifying the solubility as well as the effectiveness thereof, thus enhancing the performance of the active ingredients of the agrochemicals. Besides, the use of natural ingredients in agrochemicals such as herbicide or pesticide formulations has also actively investigated.

In the preparation of herbicidal composition, the use of surfactants, oil-in-water emulsions or microemulsions which can be used with a particular group of soluble liquid formulations is usually applied to achieve the purpose of enhancing the solubility as well as the performance of the herbicides. Most of the existing technologies for preparing such performance-enhancing compositions relate to the preparation of adjuvants which are to be added at the point of application in a tank mix. Conventionally, most of the ingredients applied in these adjuvants are petrochemicals which are not environmentally friendly and are nonbiodegradable.

Prior art relating to microemulsions and their use for improving the biological efficacy of herbicides or fungicides includes PCT publication No. WO2008019891. This document discloses a homogeneous and stable adjuvant in the form of microemulsions for use in agriculture. This adjuvant comprises a mixture of surfactants including anionic derivatives of an alkyl polyglucoside, alkyl polyglycosides, anionic derivatives of a fatty acid alcohol, methyl esters of fatty acids derived from the transesterification of vegetable oils, vegetable oils or mixture thereof, nonionic surfactants and water. The composition is formulated as an adjuvant to be used as a tank mix additive to postemergence herbicides or foliar treatment fungicides.

Another patented technology pertaining to microemulsions as adjuvants for agrochemicals is disclosed in U.S. Patent No. US20040235668. This document discloses a microemulsion composition for use as an adjuvant with agrochemicals, comprising an oil phase component, a hydrophilic emulsifier, a lipophilic co-emulsifier and water. The oil phase component can be methyl oleate or methyl laurate; the hydrophilic emulsifier is alkyl polyglucoside; whereas the lipophilic co-emulsifier is glycerol monooleate or sorbitan monolaurate. This invention discloses the use of mineral oils, vegetable oils, paraffinic oils, silicone oil and fatty acid esters. The composition provided is, however, applied as an adjuvant.

Another U.S. Pat. No. 5,888,934 also relates to herbicidal compositions and adjuvant composition comprising alkyl polyglucoside and ethoxylated alcohol surfactants. This document discloses a glyphosate composition comprising N-phosphonomethylglycine, alkyl polyglucoside, an ethoxylated alcohol, an additional surfactant of ammonium or amide group and a hemectant. This composition is a mixture of herbicides and adjuvants.

Most of the existing technologies relate to the composition of adjuvants or microemulsions which are manufactured using undesirable petrochemical raw materials or mineral oils. It is therefore a need for the present invention to provide an oleochemicals-based performance-enhancing composition for use in both ionic and nonionic soluble liquid herbicide formulations, especially herbicides having active ingredients such as glyphosate, to overcome the drawbacks of the prior art. Desirably, this performance-enhancing composition shall be a potentiator. Similar to an adjuvant, a potentiator does not contain any pesticidal or active ingredients of its own. However, unlike the adjuvant which is to be added at the point of application in a tank mix and requires meticulous dilution and mixing processes, the potentiator can be used in a concentrated formulation to be mixed with an active herbicidal compound for enhancing its performance, and the mixture is stable and can be stored for a long period. Hence, the shelf life stability of the concentrated formulations can be improved.

### SUMMARY OF INVENTION

The primary object of the present invention provides a potentiator suitable for enhancing the performance of both ionic and nonionic soluble liquid herbicide formulations, especially herbicides having glyphosate as their active ingredients.

Another object of the present invention is to innovate a potentiator having a homogeneous composition of microemulsion which contains surfactants and co-surfactants suitable for modifying the solubility and enhancing the performance of the soluble liquid herbicide formulations.

Still another object of the present invention is to develop a potentiator which can be mixed with an agrochemical or a herbicide formulation and be stably stored in the mixture form until use.

Yet another object of the present invention is to provide a potentiator which can be used together with an agrochemical or a herbicide formulation in the field with or without simple dilution with water.

Further object of the present invention is to optimize the use of natural oils in the agrochemical industry and to replace the petrochemical-based herbicide formulations by providing environmentally friendly oleochemical-based herbicide formulations.

At lease one of the preceding objects is met, in whole or in part, by the present invention, in which one of the embodiments of the present invention describes an emulsion composition for use as potentiator in a soluble liquid herbicide formulation comprising a natural oil-based ester, a hydrophilic surfactant, a lipophilic surfactant, a natural oil-based ethanolamide co-surfactant and a natural oil-based glyceride ethoxylate co-surfactant.

One of the preferred embodiments of the present invention discloses that the natural oil-based ester is palm stearin methyl ester or ethyl ester. The natural oil-based ester can also be derived from palm oil, palm kernel oil, olive oil, sunflower oil, soybean oil, peanut oil, rapeseed oil, almond oil, coconut oil, tallow oil, fish oil, or their fractions. Preferably, the natural oil-based ester has 6 to 22 carbon atoms. According to the preferred embodiment of the present invention, the natural oil-based ester can be present in an amount of 4% to 50% by weight of the composition.

In another preferred embodiment, the present invention discloses a composition for use as potentiator, in which the hydrophilic surfactant is an alkyl polyglucoside, preferably having 6 to 18 carbon atoms. The hydrophilic surfactant is preferably present in an amount of 10% to 50% by weight of the composition.

Still another preferred embodiment of the present invention discloses that the lipophilic surfactant is glycerol monoester, a fatty alcohol alkoxylate, an ethylene alkoxylate, a propylene alkoxylate or a combination of any two or more thereof. The glycerol monoester applied can be glycerol monooleate, glycerol dioleate, glycerol monolaurate or glycerol dilaurate; whereas the fatty alcohol alkoxylate, ethylene alkoxylate, propylene alkoxylate or a combination of any two or more thereof is preferably having 1 to 20 moles of ethylene oxide. Accordingly, the lipophilic surfactant is present in an amount of 4% to 20% by weight of the emulsion.

Besides, the composition of potentiator also comprises a natural oil-based ethanolamide co-surfactant which is preferably a monoethanolamide or diethanolamide derived from palm kernel oil or coconut oil, according to another embodiment of the present invention. The natural oil-based ethanolamide co-surfactant applied can have a carbon chain of 6 to 18 atoms. This natural oil-based diethanolamide co-surfactant is preferably present in an amount of 1% to 10% by weight of the composition.

According to yet another preferred embodiment of the present invention, the natural oil-based glyceride ethoxylate co-surfactant is castor oil ethoxylate or soy bean oil ethoxylate. More preferably, it is a castor oil ethoxylate having 20 to 60 moles of ethylene oxide. This natural oil-based glyceride ethoxylate co-surfactant is present in an amount of 1% to 10% by weight of the composition.

In addition, the emulsion composition of the present invention also further comprises a humectant which can be glycerol, ethylene glycol or propylene glycol. Preferably, the humectant is present in an amount of 1% to 10% by weight of the composition.

Besides, there is also a preferred embodiment of the present invention disclosing an emulsion composition of potentiator which further comprises an aqueous solvent. Preferably, the aqueous solvent is water. The emulsion is preferably an aqueous emulsion.

Although the potentiator of the invention can be used with a wide selection of agrochemicals, it is particularly suitable for use with herbicide formulations containing glyphosate as active ingredients.

There is another embodiment of the present invention disclosing a method for preparing an emulsion composition for use as potentiator in a soluble liquid herbicide, comprising the steps of premixing a hydrophilic surfactant, a natural oil-based ethanolamide co-surfactant, a natural oil-based glyceride ethoxylate co-surfactant and water to obtain a first-phase homogenized composition; mixing a natural oil-based ester with a lipophilic surfactant to obtain a second-phase homogenized composition; and adding the first-phase homogenized composition into the second-phase homogenized composition to obtain the emulsion composition. Preferably, all the preparation steps of this method are conducted at a temperature range of 50° C. to 60° C. A humectant is also preferably added into the composition during the premixing step.

The invention also provides a soluble liquid herbicide formulation comprising a herbicide and an emulsion composition of potentiator having a natural oil-based ester, a hydrophilic surfactant, a lipophilic surfactant, a natural oil-based ethanolamide co-surfactant and a natural oil-based glyceride ethoxylate co-surfactant. Preferably, the potentiator is present in an amount of 7% to 20% by weight of the formulation. As mentioned, the preferred herbicide is glyphosate.

According to a further embodiment of the present invention, a method for enhancing the performance of a soluble liquid herbicide formulation comprises adding to the herbicide formulation an emulsion composition of potentiator having a natural oil-based ester, a hydrophilic surfactant, a lipophilic surfactant, a natural oil-based ethanolamide co-surfactant and a natural oil-based glyceride ethoxylate co-surfactant.

Yet another further embodiment of the present invention discloses the use of an emulsion composition comprising a natural oil-based ester, a hydrophilic surfactant, a lipophilic surfactant, a natural oil-based ethanolamide co-surfactant and a natural oil-based glyceride ethoxylate co-surfactant as a potentiator for enhancing the performance of a soluble liquid herbicide formulation.

The adjuvant disclosed in the existing technologies can only be mixed with the active ingredients of an agrochemical and diluted with solvent at the time when it is to be applied in the field. On the contrary, the emulsion composition of potentiator provided by the present invention can be mixed with the active ingredients of an agrochemical, and be stored in the form of the emulsified mixture for a long period until it is used. This is because of the effective and stable surfactant system formulated in the emulsion composition.

One skilled in the art will readily appreciate that the present invention is well adapted to carry out the objects and obtain the ends and advantages mentioned, as well as those inherent therein. The embodiments described herein are not intended as limitations on the scope of the invention.

### DETAILED DESCRIPTION OF THE INVENTION

The present invention relates to a potentiator for enhancing the performance of active ingredients in an agrochemical. In more particular, the present invention relates to a potentiator for both ionic and nonionic soluble liquid herbicide formulations, including herbicide formulations with active ingredients such as glyphosate.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention discloses an emulsion composition for use as potentiator in a soluble liquid herbicide formulation comprising a natural oil-based ester, a hydrophilic surfactant, a lipophilic surfactant, a natural oil-based ethanolamide co-surfactant and a natural oil-based glyceride ethoxylate co-surfactant.

According to the preferred embodiment of the present invention, the potentiator composition is prepared in a concentrated formulation. It does not contain any active chemical compound of its own. When it is used together with an agrochemical particularly herbicide, it is capable of enhancing the performance of the active herbicidal ingredients and improving the shelf life stability of the herbicidal formulation, thus extending its weed-killing effects.

In the present invention, a large percentage of natural oil-derived ingredients is utilized in the emulsion composition of potentiator. Therefore, the composition provided is environmentally friendly. According to one of the preferred embodiments of the present invention, the natural oil-based ester used is palm stearin methyl ester or palm stearin ethyl ester. It is to be noted that the present invention does not intend to limit the use of esters from other suitable natural oils or their fractions. The methyl esters or ethyl esters used can be derived from palm oil, palm kernel oil, olive oil, sunflower oil, soybean oil, peanut oil, rapeseed oil, almond oil, coconut oil, tallow oil or fish oil. Preferably, the natural oil-based ester has 6 to 22 carbon atoms.

The potentiator composition is prepared in an emulsion form, wherein the emulsion is preferably a homogeneous composition of soluble liquid with droplets particles having size less than 100 nanometers. In the present invention, palm stearin methyl ester is the most preferred major ingredient to be applied as the oil phase of the emulsion. According to the preferred embodiment of the present invention, this natural oil-based ester can be present in the emulsion in an amount of 4% to 50% by weight of the composition depending on the desired formulations. Palm stearin methyl ester is capable of promoting the penetration of the agrochemicals or herbicides into the soils or roots of plants in order to achieve the herbicidal effects. It is also capable of delaying the re-growth of the weeds as well as improving the rainfastness of the herbicides.

Apart from the oil phase, the emulsion of the present invention also contains a hydrophilic surfactant and a lipophilic surfactant. In accordance with the preferred embodiment of the present invention, the hydrophilic surfactant is an alkyl polyglucoside, preferably having 6 to 18 carbon atoms. Alkyl polyglucoside acts as a wetting agent in the composition. It can be highly soluble in concentrated electrolyte solutions and will hydrotrope other less soluble ingredients.

According to the preferred embodiment of the present invention, the hydrophilic surfactant is preferably present in an amount of 10% to 50% by weight of the composition. The addition of this surfactant into this potentiator composition can greatly increase the solubility of herbicide formulations.

As set forth in the present description, a lipophilic surfactant or nonionic surfactant is also present in the potentiator composition. Accordingly, the lipophilic surfactant is present in an amount of 4% to 20% by weight of the emulsion. The choice of lipophilic surfactant depends on the desired formulations prepared for different applications. Preferably, the nonionic surfactant can be glycerol monoester, a fatty alcohol alkoxylate, an ethylene alkoxylate, a propylene alkoxylate or a combination of any two or more thereof.

The glycerol monoester can be glycerol monooleate, glycerol dioleate, glycerol monolaurate or glycerol dilaurate. This ingredient is an emulsifier which is capable of increasing the solubility of the ester or oil phase. Alternatively, a natural oil-based fatty alcohol alkoxylate, ethylene alkoxylate, propylene alkoxylate or a combination of any two or more thereof is utilized. Preferably, the natural oil-based alkoxylate used is a fatty alcohol ethoxylate having a low hydrophilic-lipophilic balance value of 1 to 20 moles of ethylene oxide. This fatty alcohol ethoxylate is suitable to be used with high viscosity and low pH agrochemical formulations for lowering their viscosity.

In order to provide a homogeneous composition of the potentiator, one or more co-surfactants are also incorporated. Each of these co-surfactants plays a respective role to form a stable and effective surfactant system. The co-surfactants chosen are oleochemicals. Preferably, the natural oil-based ethanolamide co-surfactant applied in the present invention is a monoethanolamide or diethanolamide derived from palm kernel oil or coconut oil or their fractions. The most preferred natural oil-based ethanolamide is palm kernel oil diethanolamide which can be commercially obtained. This natural oil-based ethanolamide co-surfactant is present in an amount of 1% to 10% by weight of the composition.

Likewise, the natural oil-based glyceride ethoxylate co-surfactant can be castor oil ethoxylate or soy bean oil ethoxylate, which is derived from vegetable. More preferably, it is a castor oil ethoxylate having 20 to 60 moles of ethylene oxide. The castor oil ethoxylate compound can be a mixture of various lipophilic and hydrophilic components, therefore it is capable of solubilizing various types of ionic and nonionic solid liquid herbicide formulations. According to the preferred embodiment of the present invention, this natural oil-based glyceride ethoxylate co-surfactant is present in an amount of 1% to 10% by weight of the composition.

In addition, the emulsion composition of the present invention also further comprises a humectant which can be glycerol, ethylene glycol or propylene glycol. Preferably, the humectant is present in an amount of 1% to 10% by weight of the composition. The humectant also acts as an anti-clouding agent which is capable of lowering the freezing point of the composition.

There is also a preferred embodiment of the present invention relating to a composition of potentiator which further comprises an aqueous solvent. Preferably, the aqueous solvent is water. It is mixed with the oil phase, surfactants and co-surfactants in the emulsion to form the potentiator composition which is to be used together with the appropriate herbicide formulations.

There is another embodiment of the present invention disclosing a method for preparing an emulsion composition for use as potentiator in a soluble liquid herbicide, comprising the steps of premixing a hydrophilic surfactant, a natural oil-based ethanolamide co-surfactant, a natural oil-based glyceride ethoxylate co-surfactant and water to obtain a first-phase homogenized composition; mixing a natural oil-based ester with a lipophilic surfactant to obtain a second-phase homogenized composition; and adding the first-phase homogenized composition into the second-phase homogenized composition to obtain the emulsion composition. Preferably, a humectant is added into the composition during the premixing step. The preferred ingredients used in the preparation method are as set forth in the preceding description.

Preferably, all the preparation steps of this method are conducted at a temperature range of 50° C. to 60° C., until a homogenized clear emulsion is obtained. Examples of the preparation of the potentiator composition is further detailed in Example 1 and Example 2.

Further embodiment of the present invention discloses that the herbicide formulation to be used with the potentiator can be those containing glyphosate as active ingredients. Glyphosate is also known as N-(phosphonomethyl)glycine. It is a broad-spectrum herbicide used to kill a wide variety of weeds, especially perennials. This herbicide formulation can be applied in the field of agriculture, horticulture, silviculture as well as garden maintenance. The potentiator of the present invention can be used directly with the herbicide formulations of glyphosate in an amount of 7% to 20% by weight of the formulation, in which the active ingredients used can be approximately 30% to 50% of the formulation. Should further dilution is required, aqueous solvent such as water can be applied instead of organic solvent, as the potentiator composition is able to provide good solubility to the formulations. An example of the application of the potentiator composition as well as its bioefficacy study is further detailed in Example 3.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

### EXAMPLE

Examples are provided below to illustrate different aspects and embodiments of the present invention. These examples are not intended in any way to limit the disclosed invention, which is limited only by the claims.

### Example 1

Table 1 shows one of the formulations of the potentiator, namely potentiator A, prepared according to one of the preferred embodiments of the present invention.

TABLE 1

| Chemical composition | Weight % |
|---|---|
| Palm stearin methyl ester | 10 |
| Fatty alcohol ethoxylate 2EO | 5 |
| C8-10 alkyl polyglucoside | 30 |
| Palm kernel oil diethanolamide | 4 |
| Castor oil ethoxylate 36EO | 2 |
| Glycerine | 3 |
| Water | 46 |

The commercially obtained C8-10 alkyl polyglucoside, palm kernel oil diethanolamide, castor oil ethoxylate 36EO, glycerine and water were premixed at 50° C. to 60° C. to obtain a homogenized product of phase 1. Subsequently, palm stearin methyl ester was mixed with fatty alcohol ethoxylate 2EO at 50° C. to 60° C., and the product of phase 1 was slowly added into the mixture while stirring at the same range of temperature until the mixture homogenized and a clear solution was obtained.

### Example 2

Table 2 shows one of the formulations of the potentiator, namely potentiator B, prepared according to one of the preferred embodiments of the present invention.

TABLE 2

| Chemical composition | Weight % |
|---|---|
| Palm stearin methyl ester | 25 |
| Glycerol mono oleate, 90% | 10 |
| C8-10 alkyl polyglucoside | 32 |
| Palm kernel oil diethanolamide | 4 |
| Castor oil ethoxylate 36EO | 8 |
| Glycerine | 3 |
| Water | 18 |

The commercially obtained C8-10 alkyl polyglucoside, palm kernel oil diethanolamide, castor oil ethoxylate 36EO, glycerine and water were premixed at 50° C. to 60° C. to obtain a homogenized product of phase 1. Subsequently, palm stearin methyl ester was mixed with glycerol mono oleate (90%) at 50° C. to 60° C., and the product of phase 1 was slowly added into the mixture while stirring at the same range of temperature until the mixture homogenized and a clear solution was obtained.

### Example 3

An example of application of the potentiator as described in one of the preferred embodiments of the present invention is provided herein. Initially, glyphosate pesticide concentrate was prepared by mixing 66% of Glyphosate IPA- (62% conc.) with 15% or 10% of A or B, which were prepared according to the formulations of Table 1 or Table 2, respectively. The efficacy of the agrochemical mixture was tested based on the following bioefficacy test:

Bioefficacy Test:
1. Target weeds: General weeds, dominant by Digitaria sp. and Paspalum conjugatum
2. Test condition: Open area Plot size: 1 m×5 m Replicate: 3
3. Design: Completely randomized
4. Trial period 10 weeks
5. Equipment: Knapsack sprayer fitted with a fan-jet nozzle
6. Dilution rate: 110 ml of the glyphosate pesticide concentrate make up to 16 liter with water.
7. Spray volume: 3 L/ha
8. Treatment schedule: 1 day after pre-assessment
9. Application method: Single spraying on weeds that are actively growing
10. Assessment: 1 weeks, 5 weeks, 10 weeks.
11. Assessment method: Visual assessment
12. % weed control using a 0-100 rating scale, where
   0: no effect
   50: 50% reduction in biomass
   100: plant dead

The bioefficacy test results of glyphosate herbicide formulations with potentiator A and B is tabulated in Table 3. Result showed successfully weed control (>70% weed killed within 3 weeks) for all the formulations and the efficacy is comparable to commercial sample samples.

TABLE 3

| | Bioefficacy | | |
|---|---|---|---|
| | Week after | | |
| | treatment | | |
| — | 1 | 5 | 10 |
| Control | 0 | 0 | 0 |
| Commercial herbicide | 30 | 95 | 78 |
| A 15% | 32 | 97 | 80 |
| A 10% | 27 | 92 | 77 |
| B 15% | 30 | 95 | 78 |

1. An emulsion composition for use as potentiator in a soluble liquid herbicide formulation comprising a natural oil-based ester, a hydrophilic surfactant, a lipophilic surfactant, a natural oil-based ethanolamide co-surfactant and a natural oil-based glyceride ethoxylate co-surfactant.

2. A composition according to claim 1, wherein the natural oil-based ester is derived from palm oil, palm kernel oil, olive oil, sunflower oil, soybean oil, peanut oil, rapeseed oil, almond oil, coconut oil, tallow oil, fish oil, or fractions thereof.

3. A composition according to claim 1, wherein the natural oil-based ester is palm stearin methyl ester or palm stearin ethyl ester.

4. A composition according to claim 1, wherein the natural oil-based ester has 6 to 22 carbon atoms.

5. A composition according to claim 1, wherein the natural oil-based ester is present in an amount of 4% to 50% by weight of the composition.

6. A composition according to claim 1, wherein the hydrophilic surfactant is an alkyl polyglucoside.

7. A composition according to claim 6, wherein the alkyl polyglucoside has 6 to 18 carbon atoms.

8. A composition according to claim 1, wherein the hydrophilic surfactant is present in an amount of 10% to 50% by weight of the composition.

9. A composition according to claim 1, wherein the lipophilic surfactant is glycerol monoester, a fatty alcohol alkoxylate, an ethylene alkoxylate, a propylene alkoxylate or a combination of any two or more thereof.

10. A composition according to claim 9, wherein the fatty alcohol alkoxylate is a fatty alcohol ethoxylate having 1 to 20 moles of ethylene oxide.

11. A composition according to claim 1, wherein the lipophilic surfactant is present in an amount of 4% to 20% by weight of the emulsion.

12. A composition according to claim 1, wherein the natural oil-based ethanolamide co-surfactant is a monoethanolamide or diethanolamide derived from palm kernel oil or coconut oil.

13. A composition according to claim 12, wherein the natural oil-based ethanolamide co-surfactant is present in an amount of 1% to 10% by weight of the composition.

14. A composition according to claim 1, wherein the natural oil-based glyceride ethoxylate co-surfactant is castor oil ethoxylate or soy bean oil ethoxylate.

15. A composition according to claim 14, wherein the castor oil ethoxylate has 20 to 60 moles of ethylene oxide.

16. A composition according to claim 1, wherein the natural oil-based glyceride ethoxylate co-surfactant is present in an amount of 1% to 10% by weight of the composition.

17. A composition according to claim 1 further comprising a humectant.

18. A composition according to claim 17, wherein the humectant is glycerol, ethylene glycol or propylene glycol.

19. A composition according to claim 17, wherein the humectant is present in an amount of 1% to 10% by weight of the composition.

20. A composition according to claim 1 further comprising an aqueous solvent.

21. A composition according to claim 1, wherein the herbicide formulation contains glyphosate.

22. A method for preparing an emulsion composition for use as potentiator in a soluble liquid herbicide, comprising:
premixing a hydrophilic surfactant, a natural oil-based ethanolamide co-surfactant, a natural oil-based glyceride ethoxylate co-surfactant and water to obtain a first-phase homogenized composition;
mixing a natural oil-based ester with a lipophilic surfactant to obtain a second-phase homogenized composition; and
adding the first-phase homogenized composition into the second-phase homogenized composition to obtain the emulsion composition.

23. A method according to claim 22, wherein the premixing, mixing and adding steps are conducted at a temperature range of 50° C. to 60° C.

24. A method according to claim 22, wherein a humectant is added into the composition during the premixing step.

25. A soluble liquid herbicide formulation comprising a herbicide and an emulsion composition of potentiator having a natural oil-based ester, a hydrophilic surfactant, a lipophilic surfactant, a natural oil-based ethanolamide co-surfactant and a natural oil-based glyceride ethoxylate co-surfactant.

26. A formulation according to claim 22, wherein the emulsion composition is present in an amount of 7% to 20% by weight of the formulation.

27. A formulation according to claim 22, wherein the herbicide is glyphosate.

28. A method for enhancing the performance of a soluble liquid herbicide formulation comprising a step of adding to the herbicide formulation an emulsion composition of potentiator having a natural oil-based ester, a hydrophilic surfactant, a lipophilic surfactant, a natural oil-based ethanolamide co-surfactant and a natural oil-based glyceride ethoxylate co-surfactant.

29. A method according to claim 25, wherein the added amount of the composition is 7% to 20% by weight of the formulation.

30. A method according to claim 25, wherein the herbicide formulation contains glyphosate.

31. Use of an emulsion composition comprising a natural oil-based ester, a hydrophilic surfactant, a lipophilic surfactant, a natural oil-based ethanolamide co-surfactant and a natural oil-based glyceride ethoxylate co-surfactant as a potentiator for enhancing the performance of a soluble liquid herbicide formulation.
